(19) United States
(12) Patent Application Publication
(10) Pub. No.: US 2026/0014807 A1
(43) Pub. Date: Jan. 15, 2026

(54) STRUCTURE AND METHOD FOR AUTOMATICALLY MEASURING PAPER SIZE FOR PRINTER

(71) Applicant: GUANGZHOU MUNBYN INFORMATION TECH CO LTD, GUANGZHOU (CN)

(72) Inventors: Zhuo Jia, Guangzhou (CN); Jinpeng Yuan, Guangzhou (CN); Shuzhong Liu, Guangzhou (CN); Dongrui Li, Guangzhou (CN); Qi Wang, Guangzhou (CN)

(21) Appl. No.: 18/830,553

(22) Filed: Sep. 10, 2024

(30) Foreign Application Priority Data
Jul. 12, 2024 (CN) 2024109370455

(51) Int. Cl. B41J 11/00

(52) U.S. Cl. CPC B41J 11/003

(57) ABSTRACT

The invention is a structure and a method for automatically measuring a paper size for a printer, where the structure includes: a width adjustment mechanism installed in the printer, at least one restraint arm driven by the width adjustment mechanism, a photoelectric sensor installed at a paper inlet of the printer, and a paper feeding module, where an inductor is also arranged inside the printer, and the width adjustment mechanism or the restraint arm triggers the inductor when sliding unidirectionally. Benefits of the present invention are as follows:

### CROSS REFERENCE TO RELATED APPLICATIONS

The present application claims the priority of Chinese patent application No. 2024109370455, filed on Jul. 12, 2024, and contents of which are incorporated herein by reference.

### TECHNICAL FIELD

The present invention relates to the technical field of printers, and in particular, to a structure and a method for automatically measuring a paper size for a printer.

### TECHNICAL BACKGROUND

A paper width adjustment mechanism is provided inside a printer, and a user can control the paper width adjustment mechanism to clamp paper based on a paper size, to ensure that the paper can pass through a printing area of the printer properly and smoothly, thereby avoiding problems such as a paper jam and printing dislocation caused by a mismatched paper size. Therefore, the user needs to set a length and a width of the paper in an application in a computer end or a mobile phone end, and to edit to-be-printed content within this size scope, so that an area of the to-be-printed content matches an actual area of the paper.

However, when the user has no measuring tool or has difficulty in obtaining the paper size, the user is unlikely to know how to set the paper size. Therefore, if the size is set to be inconsistent with an actual size of the paper, a fault such as offset, missing, or cross-page printing of to-be-printed text or patterns may be caused, resulting in a waste of consumables such as paper and ink.

### SUMMARY

In view of the foregoing problem, the present invention proposes a structure and a method for automatically measuring a paper size for a printer, which are mainly intended to resolve a problem that the printer lacks a paper size measuring function.

To resolve the foregoing technical problem, a first aspect of the present invention provides a structure for automatically measuring a paper size for a printer, including: a width adjustment mechanism installed in the printer, at least one restraint arm driven by the width adjustment mechanism, a photoelectric sensor installed at a paper inlet of the printer, and a paper feeding module, where an inductor is also arranged inside the printer, and the width adjustment mechanism or the restraint arm triggers the inductor when sliding unidirectionally.

In some embodiments, the width adjustment mechanism includes an adjustment gear and a right rack and a left rack meshing with upper and lower ends of the adjustment gear respectively, a restraint arm is fixed at each remote end of the right rack and the left rack, and an upper end surface of the right rack comes into contact with the inductor when sliding under drive of the adjustment gear, or a lower end surface of the left rack comes into contact with the inductor when sliding under drive of the adjustment gear.

In some embodiments, the two restraint arms are arranged in parallel at the paper inlet of the printer.

In some embodiments, a guide slope is arranged on one side, closer to the inductor, of the upper end surface of the right rack or the left rack.

In some embodiments, the guide slope forms a fillet or a chamfer.

In some embodiments, the inductor is a multipoint contact induction sensor, and a distribution direction of contact points on a surface of the contact induction sensor is consistent with a sliding direction of the right rack.

In some embodiments, a hemispherical bump is arranged on one side, closer to the inductor, of an upper end surface of the right rack or the left rack, the bump is located in a vertical plane formed by multiple contact points, and the bump sequentially comes into contact with the contact points on the inductor when driven to slide.

In some embodiments, the bump is detachably installed on the upper end surface of the right rack, and a height for installing the inductor is adjustable.

A second aspect of the present invention proposes a method for automatically measuring a paper size for a printer, applicable to the foregoing measuring structure and including the following steps:
when a printing module of the printer enters a silent mode, feeding paper into the paper inlet of the printer, and manually pushing the restraint arm, or controlling the width adjustment mechanism to drive the restraint arm, so that the restraint arm properly clamps the paper, to finally drive the paper feeding module;
transmitting, to a host computer, first state information output by the inductor and second state information output by the photoelectric sensor, where the first state information is an array signal triggered when the inductor is pressed by the right rack or the left rack, and the second state information is two adjacent hopping signals obtained by the photoelectric sensor;
calling, by the host computer, a mapping relationship, and searching for a corresponding paper width from the mapping relationship according to the array signal; and
querying, by the host computer, generation moments of the two hopping signals, calculating the quantity of operating steps of a stepping motor in the paper feeding module according to the two generation moments, obtaining a step size of the paper feeding module, and calculating a paper length according to the quantity of operating steps and the step size.

In some embodiments, the array signal includes multiple binary state values, and each state value corresponds to a pressing state of a contact induction sensor, where the mapping relationship includes multiple groups of array signals and multiple groups of paper widths corresponding to the array signals.

Benefits of the present invention are as follows: The inductor is arranged inside the printer, and in this way, during use, the user can directly manually push the restraint arm or control the width adjustment mechanism to drive the restraint arm, so that the restraint arm properly clamps the paper. The width adjustment mechanism or the restraint arm comes into contact with the inductor when sliding, the paper width is indirectly measured according to a displacement signal output by the inductor, and the user can send, to the host computer, a displacement obtained by the inductor and determine the actual paper width through the preset mapping relationship in the host computer without needing a length measurement tool. In addition, the actual paper length is obtained by using both the photoelectric sensor and the paper feeding module, thereby automatically measuring the paper size.

### BRIEF DESCRIPTION OF THE DRAWINGS

FIG. 1 is a schematic structural diagram of a structure for automatically measuring a paper size for a printer disclosed in Embodiment 1 of the present invention;

FIG. 2 is a schematic structural diagram of a width adjustment mechanism disclosed in Embodiment 1 of the present invention; and

FIG. 3 is a schematic structural diagram of another width adjustment mechanism disclosed in Embodiment 1 of the present invention.
Reference signs: 1—printer, 2—width adjustment mechanism, 3—restraint arm, 4—inductor, 5—photoelectric sensor, 201—adjustment gear, 202—left rack, 203—right rack, 204—bump, and 205—guide slope.

### DETAILED DESCRIPTION OF EMBODIMENTS

To make the purpose, the technical solution and the advantage of the present invention clearer and more explicit, content of the present invention is further described in detail below with reference to the accompanying drawings and embodiments. It should be understood that, the embodiments described here are only intended to explain the present invention rather than limit the present invention. In addition, it should also be noted that, for ease of description, only some contents related to the present invention other than all the contents are shown in the drawings.

### Embodiment 1

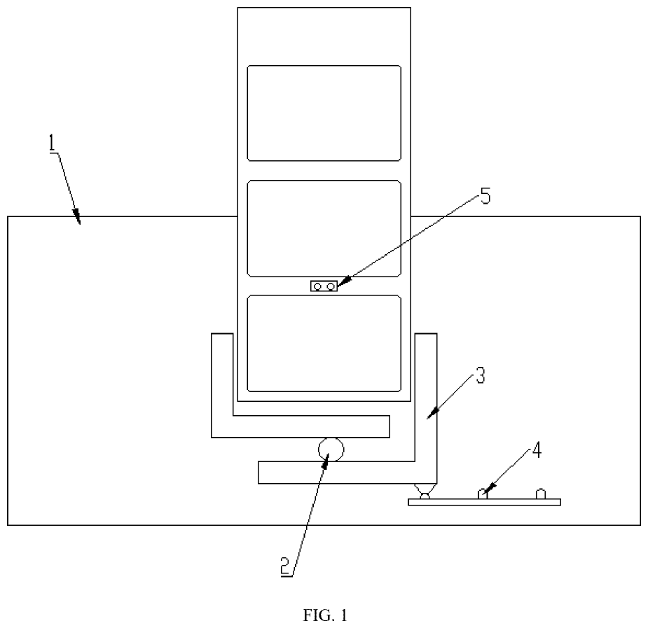

This embodiment proposes a structure for automatically measuring a paper size for a printer. As shown in FIG. 1, the structure includes: a width adjustment mechanism 2 installed in the printer 1, at least one restraint arm 3 driven by the width adjustment mechanism, a photoelectric sensor 5 installed at a paper inlet of the printer, and a paper feeding module (not shown in the figure, where the component is a regular structure of the printer), where an inductor 4 is also arranged inside the printer 1, and the width adjustment mechanism 2 or the restraint arm 3 triggers the inductor 4 when sliding unidirectionally (contact is or is not involved). It should be noted that, the foregoing restraint arm 3 is used to limit the paper width, and there should be at least one restraint arm 3. In this case, one side of the paper can be fixed with one restraint arm 3, and the other side of the paper is fixed with one end of the paper inlet of the printer 1. Optionally, a solution of double restraint arms can also be adopted, and two restraint arms 3 can be used to fix the two sides of the paper.

In this embodiment, the inductor 4 is arranged inside the printer 1, and in this way, during use, the user can directly manually push the restraint arm 3 or control the width adjustment mechanism 2 to drive the restraint arm 3, so that the restraint arm 3 properly clamps the paper. The width adjustment mechanism 2 or the restraint arm 3 comes into contact with the inductor 4 when sliding, the paper width is indirectly measured according to a displacement signal output by the inductor 4, and the user can send, to the host computer, a displacement obtained by the inductor 4 and determine the actual paper width through the preset mapping relationship in the host computer without needing a length measurement tool. In addition, the actual paper length is obtained by using both the photoelectric sensor 5 and the paper feeding module 6, thereby automatically measuring the paper size.

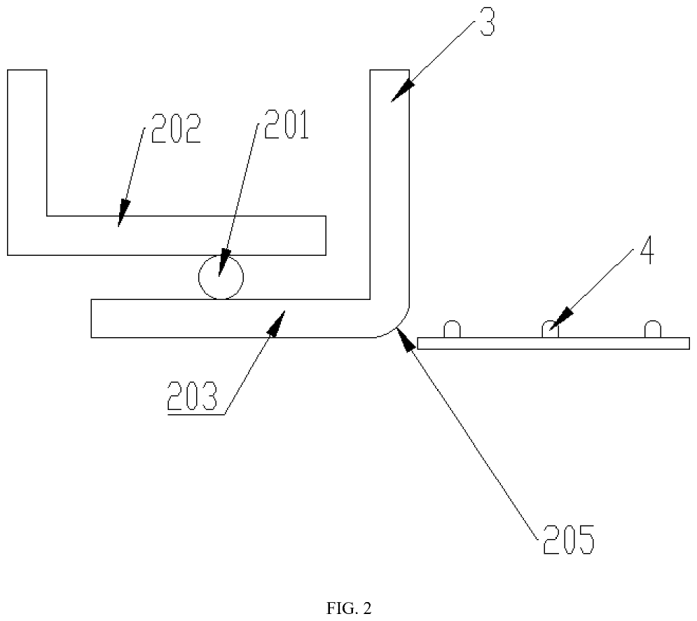

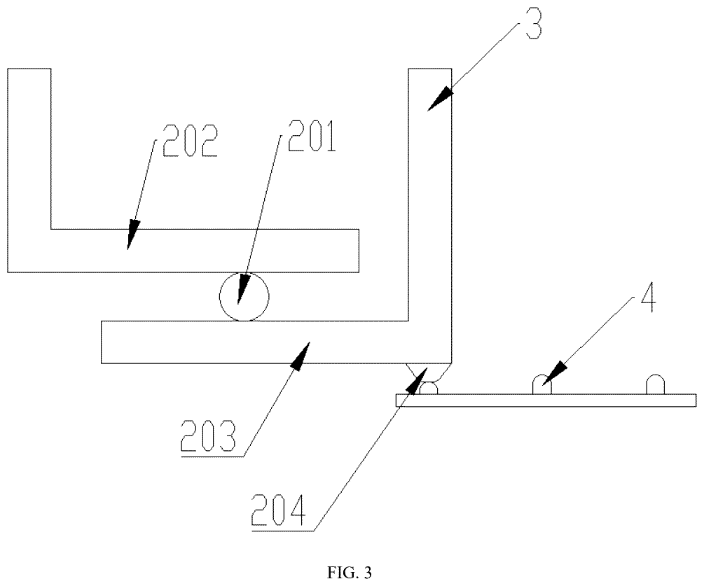

In the present invention, either of the width adjustment mechanism 2 or the restraint arm 3 can be used as a part specifically in contact with the inductor 4. In an optional solution, taking, as an example, the width adjustment mechanism 2 serving as a contact member, as shown in FIG. 2, the width adjustment mechanism 2 includes an adjustment gear 201 and a right rack 203 and a left rack 202 meshing with upper and lower ends of the adjustment gear 201 respectively, a restraint arm 3 is fixed at each remote end of the right rack 203 and the left rack 202, and an upper end surface of the right rack 203 comes into contact with the inductor 4 when sliding under drive of the adjustment gear 201, or optionally, a lower end surface of the left rack 202 comes into contact with the inductor 4 when sliding under drive of the adjustment gear 201. Taking manual pushing of the restraint arm 3 on the right rack 203 as an example, assuming that the right rack 203 slides towards the inductor 4, an upper surface of the right rack 203 continuously comes in contact with detection points on the inductor 4 during sliding, to detect a route of the right rack 203 and output a corresponding displacement signal accordingly. In this case, the adjustment gear 201 rotates counterclockwise, and drives the left rack 202 to slide rightward, to synchronously control the two restraint arms 3. In the foregoing solution, when the manner of manually driving the restraint arm 3 is adopted, the adjustment gear 201 is only used as a connecting member between the right rack 203 and the left rack 202; but, when a manner of electrically driving the restraint arm 3 is adopted, rotation of the adjustment gear 201 can be controlled by the motor, and two restraint arms 3 are controlled to move towards each other to clamp the paper. Optionally, start and stop of the motor can be controlled by the sensor via, for example, visual detection or sensor detection. When the restraint arm 3 comes into contact with the paper, the motor stops rotating immediately.

Specifically, the two restraint arms 3 are arranged in parallel at the paper inlet of the printer 1, and the maximum opening width of the two restraint arms 3 should not exceed a width of the paper inlet.

Optionally, still referring to FIG. 2, a guide slope 205 is arranged on one side, closer to the inductor 4, of the upper end surface of the right rack 203 or the left rack 202, and the guide slope 205 optionally forms a fillet or a chamfer, to smooth a head of the right rack 203, thereby preventing the head of the right rack 203 from colliding with the inductor 4.

In an example, the inductor 4 is a multipoint contact induction sensor, and a distribution direction of contact points on a surface of the contact induction sensor is consistent with a sliding direction of the right rack 203. That is, a contact induction sensor consists of sensors 1, 2, 3, . . . . In this solution, the foregoing displacement signal is further simplified as a state of the sensor, and as shown in Table 1 below, when signals output by the sensor 1, the sensor 2, and the sensor 3 are 1, 0, and 0 respectively, it indicates that the right rack 203 only comes into contact with the sensor 1, and in this case, the paper width is W2.

Obviously, because the adjustment gear 201 is used as the connecting member in this solution, the right rack 203 and the left rack 202 move towards or opposite to each other, covering the same distance, and on this basis, a displacement change of the right rack 203 is equivalent to one-half of a change in the paper width. That is, a distance between the adjacent sensors is one-half of widths of the two types of adjacent paper, which can be used as a design reference for Table 1.

TABLE 1
Mapping Relationships Between States
of Sensors and Paper Widths

| State of | State of | State of | Paper |
|---|---|---|---|
| sensor 1 | sensor 2 | sensor 3 | widths |
| 0 | 0 | 0 | W1 |
| 1 | 0 | 0 | W2 |
| 1 | 1 | 0 | W3 |
| 1 | 1 | 1 | W4 |

In another optional solution, as shown in FIG. 3, a hemispherical bump 204 is arranged on one side, closer to the inductor 4, of an upper end surface of the right rack 203 or the left rack 202, the bump 204 is located in a vertical plane formed by multiple contact points, and the bump 204 sequentially comes into contact with the contact points on the inductor 4 when driven to slide. The solution is an alternative to a solution of direct contact between the upper end surface of the right rack 203 (namely, one side of the guide slope 205) and the inductor 4, and the bump 204 is in direct contact with the inductor 4. In this case, the bump 204 is hemispherical and therefore, has a guide function. In addition, the bump 204 is detachably installed on the upper end surface of the right rack 203, and correspondingly, a height for installing the inductor 4 is adjustable.

A signal transmitter coupled with the inductor 4 is also included, and the signal transmitter unidirectionally sends, to a mobile device or a computer with which communication has been established, a displacement signal output by the inductor 4. Therefore, the printer using the structure in this embodiment can automatically measure the paper width, and can report the automatically measured paper width to an application on a computer or a mobile phone, and then an editing interface size of label paper is automatically adjusted according to a label width, to reduce technical difficulty of using the printing device for the user, thereby reducing a printing error rate and improving printing efficiency and experience.

### Embodiment 2

This embodiment proposes a method for automatically measuring a paper size for a printer, applicable to the measuring structure in Embodiment 1 and including the following steps:

Step 1: When a printing module of the printer 1 enters a silent mode, feed paper into the paper inlet of the printer 1, and manually push the restraint arm 3, or control the width adjustment mechanism to drive the restraint arm 3, so that the restraint arm 3 properly clamps the paper, to finally drive the paper feeding module.

An objective of the solution in this embodiment is to measure the paper size, and therefore, the printing module needs to enter a silent mode to avoid a meaningless waste of ink and paper. Then, two restraint arms 3 can be manually or electrically controlled to clamp the paper to restrain the paper in the width direction, and then the paper feeding module is started, to start detecting the paper size.

Step 2: Transmit, to a host computer, first state information output by the inductor 4 and second state information output by the photoelectric sensor 5, where the first state information is an array signal triggered when the inductor 4 is pressed by the right rack 203 or the left rack 202, and the second state information is two adjacent hopping signals obtained by the photoelectric sensor 5.

For example, referring to the contact induction sensor in Embodiment 1 that consists of multiple identical sensors, and after the right rack 203 or the left rack 202 presses the contact induction sensor, the sensor generates a switch signal, that is, a state value mentioned below in this embodiment. The array signal includes multiple binary state values, and each state value corresponds to a pressing state of a contact induction sensor, where the mapping relationship includes multiple groups of array signals and multiple groups of paper widths corresponding to the array signals. Referring to Embodiment 1, assuming that signals currently output by the sensor 1, the sensor 2 and the sensor 3 are 1, 0 and 0 respectively, an array signal transmitted by the printer to the host computer is 100. After the paper feeding module drives the paper to enter the paper inlet, when the paper passes through the photoelectric sensor 5 for the first time, light emitted by the photoelectric sensor 5 (for example, a through-beam photoelectric sensor) is blocked by the paper, and a signal can hop from 1 to 0, and then hop from 0 to 1 again after the paper moves away from the photoelectric sensor 5.

Step 3: The host computer calls a mapping relationship, and searches for a corresponding paper width from the mapping relationship according to the array signal.

For a method of obtaining the paper width in step 3, refer to Table 1 disclosed in Embodiment 1. Assuming that the array signal currently sent to the host computer is 100, then the paper width finally obtained is W2 according to the mapping relationships in Table 1.

In consideration of a gap between the two sensors, an error occurs when the bump 204 moves to a position between the two sensors. Therefore, in another optional solution, the paper width in the mapping relationship is replaced with a paper width range.

Step 4: The host computer queries generation moments of the two hopping signals, calculates the quantity of operating steps of a stepping motor in the paper feeding module according to the two generation moments, obtains a step size of the paper feeding module, and calculates a paper length according to the quantity of operating steps and the step size.

The foregoing hopping signal not only can carry time information, but also can be directly sent to the host computer upon generation of the hopping signal, so that the time information is assigned by the host computer, and total time required for head and tail ends of paper to pass through the photoelectric sensor 5 can be calculated according to the moments of two hopping signals. A movement speed of the paper feeding module is known, and therefore, the paper length can be calculated by using the foregoing two parameters. In an example, if the paper consists of label paper and release paper, the release paper (transparent) is continuous, and the label paper (opaque) is arranged at intervals on the release paper, according to the principle of the solution, when the release paper passes above the photoelectric sensor 5, the light emitted by the photoelectric sensor 5 (such as the through-beam photoelectric sensor) is not blocked, and the signal does not hop. However, when the label paper passes above the photoelectric sensor 5, the light emitted by the photoelectric sensor 5 is blocked, and the signal hops from 1 to 0, and then hops from 0 to 1 again after the label paper moves away from the photoelectric sensor 5, thereby completing a round of value calculation. Certainly, to increase accuracy of the measurement, multiple groups of hopping signals are measured each time, multiple groups of paper lengths are calculated, and finally, an average of the multiple groups of paper lengths is selected to obtain the final paper length.

In addition, optionally, the method further includes step 5. Step 5: The application on the computer end or the mobile phone end with respect to the printer obtains the paper width and the paper length from the host computer, and adjusts a size of paper in the editing interface of the user according to the obtained paper width and paper length.

The foregoing embodiments are only intended to illustrate a technical idea and characteristics of the present invention, so that persons of ordinary skills in the art can understand content of the present invention and implement it accordingly, and the protection scope of the present invention is not limited thereto. Any equivalent changes or modifications made according to substance of the content of the present invention shall fall within the protection scope of the present invention.

The present invention discloses a structure and a method for automatically measuring a paper size for a printer, where the structure includes: a width adjustment mechanism installed in the printer, at least one restraint arm driven by the width adjustment mechanism, a photoelectric sensor installed at a paper inlet of the printer, and a paper feeding module, where an inductor is also arranged inside the printer, and the width adjustment mechanism or the restraint arm triggers the inductor when sliding unidirectionally. Benefits of the present invention are as follows: The inductor is arranged inside the printer, and in this way, during use, a user can directly manually push the restraint arm or control the width adjustment mechanism to drive the restraint arm, so that the restraint arm properly clamps the paper. The width adjustment mechanism or the restraint arm triggers the inductor when sliding, and the paper width is indirectly measured according to a displacement signal output by the inductor. In addition, an actual paper length is obtained by using both the photoelectric sensor and the paper feeding module, thereby automatically measuring the paper size.

1. A structure for automatically measuring a paper size for a printer, comprising: a width adjustment mechanism installed in the printer, at least one restraint arm driven by the width adjustment mechanism, a photoelectric sensor installed at a paper inlet of the printer, and a paper feeding module, wherein an inductor is also arranged inside the printer, and the width adjustment mechanism or the restraint arm triggers the inductor when sliding unidirectionally.

2. The structure for automatically measuring a paper size for a printer according to claim 1, wherein the width adjustment mechanism comprises an adjustment gear and a right rack and a left rack meshing with upper and lower ends of the adjustment gear respectively, a restraint arm is fixed at each remote end of the right rack and the left rack, and an upper end surface of the right rack comes into contact with the inductor when sliding under drive of the adjustment gear, or a lower end surface of the left rack comes into contact with the inductor when sliding under drive of the adjustment gear.

3. The structure for automatically measuring a paper size for a printer according to claim 2, wherein the two restraint arms are arranged in parallel at the paper inlet of the printer.

4. The structure for automatically measuring a paper size for a printer according to claim 2, wherein a guide slope is arranged on one side, closer to the inductor, of the upper end surface of the right rack or the left rack.

5. The structure for automatically measuring a paper size for a printer according to claim 4, wherein the guide slope forms a fillet or a chamfer.

6. The structure for automatically measuring a paper size for a printer according to claim 2, wherein the inductor is a multipoint contact induction sensor, and a distribution direction of contact points on a surface of the contact induction sensor is consistent with a sliding direction of the right rack.

7. The structure for automatically measuring a paper size for a printer according to claim 2, wherein a hemispherical bump is arranged on one side, closer to the inductor, of an upper end surface of the right rack or the left rack, the bump is located in a vertical plane formed by multiple contact points, and the bump sequentially comes into contact with the contact points on the inductor when driven to slide.

8. The structure for automatically measuring a paper size for a printer according to claim 7, wherein the bump is detachably installed on the upper end surface of the right rack, and a height for installing the inductor is adjustable.

9. A method for automatically measuring a paper size for a printer, applicable to the measuring structure according to claim 2 and comprising the following steps:
when a printing module of the printer enters a silent mode, feeding paper into the paper inlet of the printer, and manually pushing the restraint arm, or controlling the width adjustment mechanism to drive the restraint arm, so that the restraint arm properly clamps the paper, to finally drive the paper feeding module;
transmitting, to a host computer, first state information output by the inductor and second state information output by the photoelectric sensor, wherein the first state information is an array signal triggered when the inductor is pressed by the right rack or the left rack, and the second state information is two adjacent hopping signals obtained by the photoelectric sensor;
calling, by the host computer, a mapping relationship, and searching for a corresponding paper width from the mapping relationship according to the array signal; and
querying, by the host computer, generation moments of the two hopping signals, calculating the quantity of operating steps of a stepping motor in the paper feeding module according to the two generation moments, obtaining a step size of the paper feeding module, and calculating a paper length according to the quantity of operating steps and the step size.

10. The method for automatically measuring a paper size for a printer according to claim 9, wherein the array signal comprises multiple binary state values, and each state value corresponds to a pressing state of a contact induction sensor, wherein the mapping relationship comprises multiple groups of array signals and multiple groups of paper widths corresponding to the array signals.
